(19) United States
(12) Patent Application Publication
(10) Pub. No.: US 2011/0294511 A1
(43) Pub. Date: Dec. 1, 2011

(54) Signal Covering Method and Code Division Multiple Access Wireless Cellular Communication System

(76) Inventor: Jinbo Cao, Guangdong Province (CN)

(21) Appl. No.: 13/147,846

(22) PCT Filed: Sep. 15, 2009
(86) PCT No.: PCT/CN2009/073944

§ 371 Date: Aug. 4, 2011

(30) Foreign Application Priority Data
Feb. 5, 2009 (CN) 200910006228.0

(51) Int. Cl. H04W 36/18; H04W 68/00

(52) U.S. Cl. 455/442; 455/422.1; 455/458

(57) ABSTRACT

A signal covering method and a code division multiple access wireless cellular communication system are provided. In the signal covering method, multiple cells which are adjacent or close in physical location utilize same forwarding pilot frequency pseudo-random sequence to transmit same pilot frequency channel signal. The pilot frequency channel signal from the multiple cells is received by a terminal, and the same forwarding pilot frequency pseudo-random sequence is demodulated from the pilot frequency channel signal. The technical solution disclosed in the invention enables reducing switching frequency obviously when the terminal is on standby or busy, so as to avoid problem of dropped call caused by the frequent switching, reduces dropped call rate and improves stability of a code division multiple access (CDMA) wireless cellular communication system.

### TECHNICAL FIELD OF THE INVENTION

The present invention relates to the technical field of mobile communications, in particular to a CDMA2000 1x wireless cellular communication system and a signal covering method applied in the same.

### BACKGROUND OF THE INVENTION

In the CDMA2000 1x wireless cellular system, adjacent cells distinguish from each other by transmitting pseudorandom noise (PN) short codes with different offsets, i.e. pilot pseudorandom noise offset (pilot PN offset) or pilot pseudorandom noise (Pilot PN), on a forwarding pilot channel. When a terminal locked in cell A finds that the signal strength of the received pilot PN of cell A (PNₐ) is reducing, while the signal strength of the pilot PN of an adjacent cell B (PN_{b}) is increasing, then the terminal deems itself to be moving from cell A to cell B. When the strength of PN_{b} exceeds a certain threshold, a soft handoff (or soft handover) flow will be triggered at the terminal side, PN_{b} is added in a pilot PN activation set of the terminal, and the terminal will simultaneously demodulate signals from cells A and B. With the constant reduction of the strength of PNₐ to a certain threshold, PNₐ exits the activation set, and the terminal only demodulates signals from cell B, thereby accomplishing the soft handoff from cell A to cell B. From the flow above, it can be concluded that the premise of soft handoff for the terminal is that the adjacent cells must adopt different pilot PNs.

Because of the terrestrial factor, the construction for railway or highway traffic systems is inevitable to pass through the mountains by tunnels. With the rapid development of the railway and highway traffic networks, the total mileage of the tunnels is increased swiftly too, and very long tunnel of dozens of kilometres is possible in the mountainous area with complex terrains. At present, the signal coverage of wireless communication networks for complex terrains such as tunnel is a problem for the planning of wireless network. On one hand, the deployment of radio frequency antennas in the tunnel is limited in height and angle, so, in such case, normally, the cell radius of the wireless cellular system is much smaller than the radius in general cases; on the other hand, the terminals used in the tunnel are on rapidly moving carriers, especially those in the high-speed trains or vehicles on express highways, which can pass through the coverage area of a cell within a very short period.

In the cases above, the terminals for communication are possibly handed off, even frequently handed off due to smaller cell radius and fast movement thereof. However, a call drop probably occurs due to increased handoff, particularly, the handoff in a high speed circumstance, resulting in the increase of call drop rate of a base station and the reduction of stability of the system.

### SUMMARY OF THE INVENTION

Considering the above, the present invention provides an improved signal covering solution to solve the problem in the prior art of increased call drop rate caused by the increased handoff frequency due to smaller cell radius and fast movement of terminals.

According to one aspect of the invention, a signal covering method applied in a CDMA wireless cellular communication system is provided.

The signal covering method according to the invention comprises: multiple cells which are adjacent or close in physical location transmitting a same pilot channel signal by using a same forwarding pilot pseudorandom noise.

Furthermore, after the step of transmitting the pilot channel signal, the method further comprises: a terminal receiving the pilot channel signal transmitted by the multiple cells, and demodulating the pilot channel signal to obtain the forwarding pilot pseudorandom noise.

Furthermore, after the step of demodulating the pilot channel signal to obtain the forwarding pilot pseudorandom noise, the method further comprises: if the strength of the pilot channel signal is greater than a preset first threshold, the terminal adding the forwarding pilot pseudorandom noise into a pilot activation set of the terminal.

After the step of demodulating the pilot channel signal to obtain the forwarding pilot pseudorandom noise, the method further comprises: if the strength of the pilot channel signal is smaller than a preset second threshold, the terminal removing the forwarding pilot pseudorandom noise from a pilot activation set of the terminal.

Furthermore, in the method, the multiple cells transmit, under control of a base transceiver station, a same synchronous channel signal.

Furthermore, in the method, the multiple cells transmit, under an individual control of a base transceiver station or a combined control of the base transceiver station and a base station controller, a same paging channel signal.

Furthermore, in the method, reverse access channels of the multiple cells use a same long code mask.

Furthermore, the method further comprises: a base station side receiving a reverse message sent by a terminal which is in any one of the multiple cells; and the base station side demodulating the received reverse message according to the long code mask.

Furthermore, the method further comprises: when a terminal is calling or called in any one of the multiple cells, a base station side using the other cells in the multiple cells as sectors added by a softer handoff.

According to another aspect of the invention, a code division multiple access wireless cellular communication system is provided.

The code division multiple access wireless cellular communication system according to the invention comprises: multiple cells, each of which transmits a same pilot channel signal by using a same forwarding pilot pseudorandom noise, wherein the multiple cells are adjacent or close in physical location; and a terminal, configured to receive the pilot channel signal transmitted by the multiple cells, and demodulating the pilot channel signal to obtain the forwarding pilot pseudorandom noise.

In virtue of at least one of the above solutions of the present invention, several cells which are adjacent or close in physical and geographical location transmit the same pilot channel signal by using the same pilot PN, so that the pilot channel signals received by a terminal within the coverage of these cells are the same, which equivalents to increasing the radius of the cell, thereby obviously reducing the handoff frequency when the terminal is on standby or in a conversation, solving the problems in the prior art, avoiding the problem of call drop cased by frequent handoff, reducing the call drop rate, and improving the stability of the system,

Other features and advantages of the present invention will be described in the following description, and partly become obvious from the description, or be understood by implementing the present invention. The objects and other advantages of the present invention can be realized and obtained through the structures indicated by the description, claims and drawings.

### BRIEF DESCRIPTION OF THE DRAWINGS

The drawings illustrated here provide a further understanding of the present invention and form a part of the specification. The drawings are used to explain the present invention together with the embodiments of the present invention without unduly limiting the scope of the present invention, wherein:

FIG. 1 is a flowchart of a signal covering method according to an embodiment of the present invention;

FIG. 2 is a schematic diagram of signal coverage of the adjacent cells with the same PN according to an embodiment of the present invention;

FIG. 3 is a handoff flowchart when a terminal moving from A to H in FIG. 2;

FIG. 4 is a schematic diagram of signal output of a base station according to an embodiment of the present invention; and

FIG. 5 is a structural schematic diagram of a code division multiple access wireless cellular communication system according to an embodiment of the present invention.

### DETAILED DESCRIPTION OF THE EMBODIMENTS

Functional Overview

The precondition of a handoff is that adjacent cells use different pilot PNs. Therefore, the embodiments of the present invention adopt a method in which multiple cells adjacent or close in physical location use the same pilot PN, so that the handoff can be avoided and the handoff frequency of the whole system can be reduced macroscopically.

In case of no conflict, the embodiments of the present application and features therein can be combined with each other.

A detailed description is given to the preferred embodiments of the present invention with reference to the accompanying drawings. The preferred embodiment is described for the purpose of illustration and explanation, not for limiting the present invention.

According to one embodiment of the present invention, a signal covering method is firstly provided.

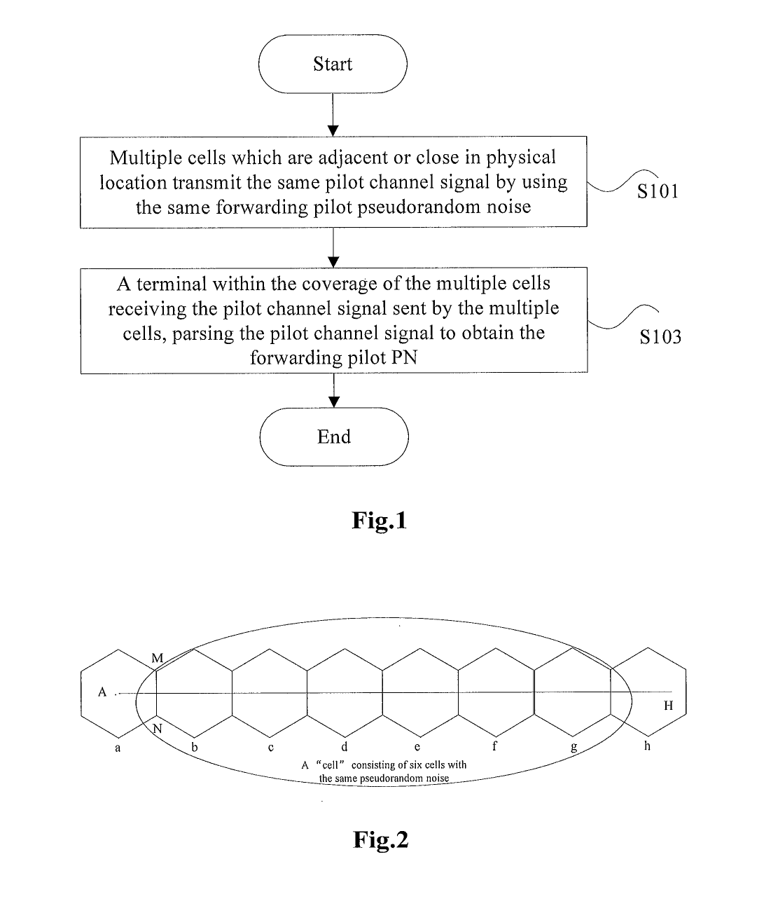

FIG. 1 is a flowchart of a signal covering method according to an embodiment of the present invention. The method is applied in a CDMA2000 1x cellular system. As shown in FIG. 1, the signal covering method mainly includes the following steps.

Step 101: Multiple cells which are adjacent or close in physical location adopt the same forwarding pilot PN, and transmit the same pilot channel signal.

During a specific implementing procedure, the number of cells using the same PN can be determined according to the specific implementing requirements.

Step 103: A terminal, within the coverage of the multiple cells, receives the pilot channel signal transmitted by the multiple cells, and parses the pilot channel signal to obtain the forwarding pilot PN.

During a specific implementing procedure, when the PN used by the multiple cells is obtained by parsing, if the PN is not in a pilot activation set of the terminal, the terminal judges whether the strength of the received pilot channel signal is greater than a preset first threshold, and if so, adds the PN obtained by demodulation in the pilot activation set of the terminal. If the PN is in the pilot activation set of the terminal, the terminal judges whether the strength of the received pilot channel signal is less than a preset second threshold, and if so, removes the PN from the pilot activation set.

During a specific implementing procedure, the value of the preset first threshold should be greater than that of the preset second threshold, and their specific values can be set according to the actual applications.

During a specific implementing procedure, the method further includes that: the multiple adjacent cells using the same PN transmit, under the control of a base transceiver station (BTS), the same synchronous channel signals, and the forwarding synchronous channel signals, transmitted by respective cells, received by the terminal within the coverage of the multiple adjacent cells, are completely the same.

Specifically, the method further includes that: the paging channels of the multiple adjacent cells using the same PN are controlled and scheduled by the base transceiver station, or uniformly controlled and scheduled by the base transceiver station and a base station controller, so as to guarantee that all adjacent cells using the same PN transmit the completely same paging channel signal. Consequently, the forwarding paging channel signals, transmitted by respective cells, received by the terminal within the coverage of the cells, are completely the same.

Specifically, in order to make the base station side demodulate the reverse messages transmitted by the terminals within the coverage of the multiple cells indistinctively, the reverse access channels of the multiple cells use the same long code mask. A reverse message sent by the terminal in any one of the multiple cells can be demodulated by the base station side indistinctively and transferred to an upper layer.

When the terminal is calling or called in any one of the multiple cells using the same PN, the base station side uses other cells in the multiple cells as sectors added by a softer handoff for processing.

In the embodiments of the present invention, the differential processing implemented among the multiple cells using the same PN can be fulfilled at the base station side and with no connection to the terminal side.

According to the above signal coverage method of the embodiments of the present invention, the adjacent cells can use the same pilot PN to make the adjacent cells using the same PN cover the same forwarding control signal, which obviously reduces the handoff frequency when the terminal is on standby or in a conversation, thereby avoiding the problems such as call drop caused by the frequent handoff.

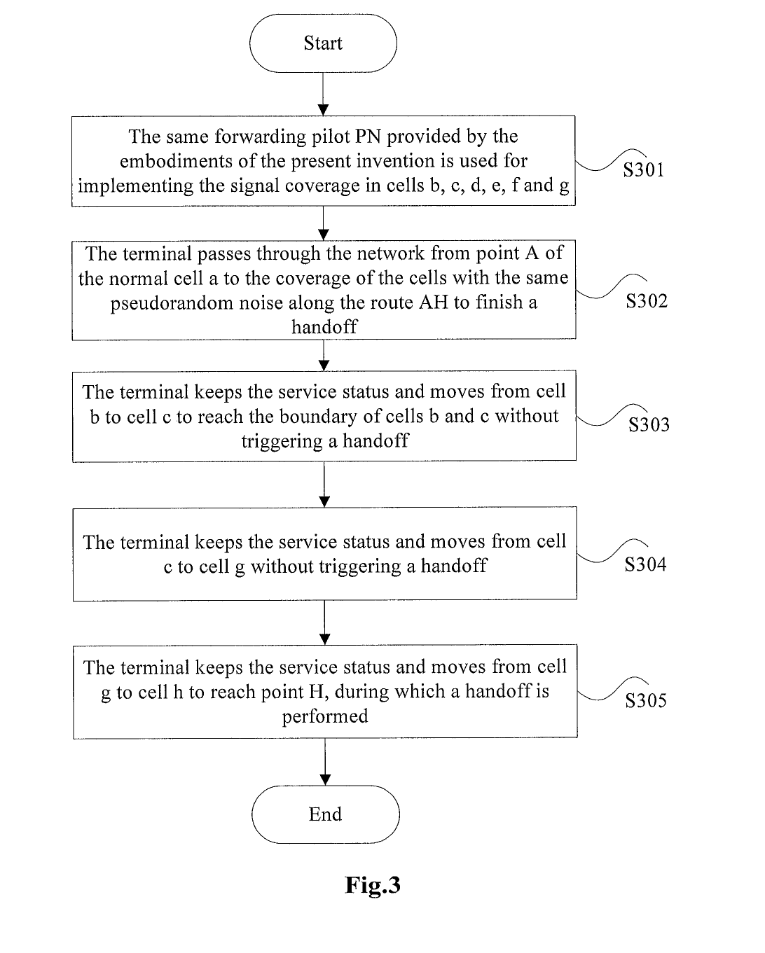

To further understand the detailed implementing manners of the technical solutions provided by the embodiments of the present invention, the following explain the detailed implementing manners of the technical solutions provided by the embodiments of the present invention by taking the cell distribution as shown in FIG. 2 as an example.

FIG. 3 is a handoff flowchart when a terminal moving from A to H in FIG. 2. As shown in FIG. 3, the handoff flow mainly includes the following steps.

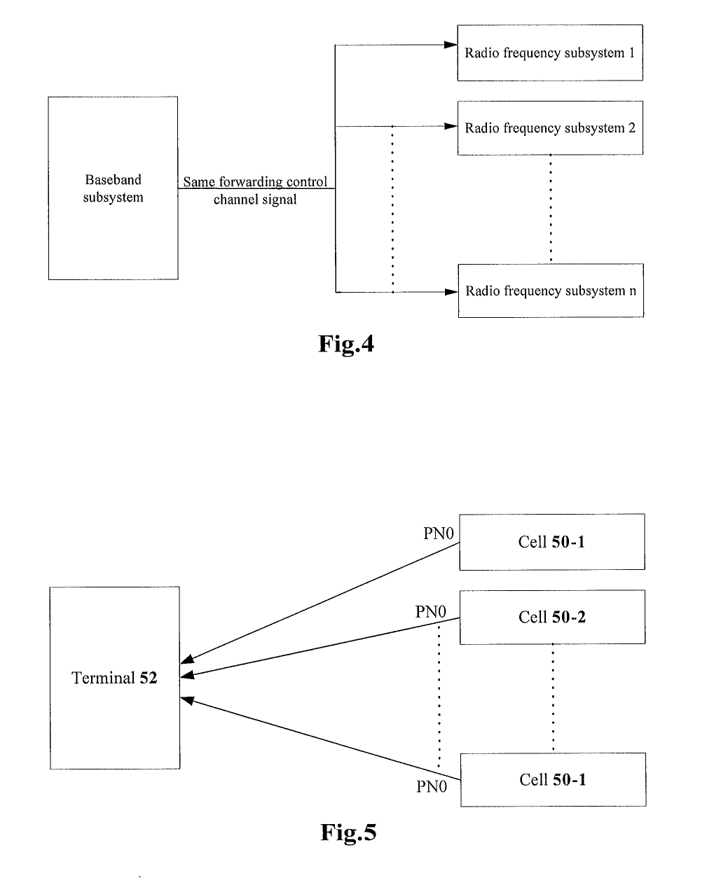

Step 301: The same forwarding pilot PN provided by the embodiments of the present invention is used by cells b, c, d, e, f and g in FIG. 2 for implementing the signal coverage of the CDMA2000 1x cellular system. As shown in FIG. 2, each hexagon represents the physical coverage of a cell. Cells b, c, d, e, f and g transmit the same pilot channel signal, synchronous channel signal and paging channel signal, respectively. That is, the forwarding control channel signals sent by the base stations in the cells b, c, d, e, f and g are completely the same, as shown in FIG. 4.

Step 302: The terminal is calling or called successfully and keeps in communication, and passes through the network of the CDMA2000 1x cellular system from point A of the normal cell a to the coverage of the cell with the same PN along the route AH.

It is assumed that the PN of cell a is PNₐ, and the cells with the same PN use the same PN (PN₀). At the area near the cell boundary MN, because the strength of PN₀ is getting stronger and exceeds a threshold, PN₀ will be added into a pilot activation set of the terminal. When the terminal passes MN to enter the dark area and moves constantly in the direction H, because the strength of PNₐ is getting weaker and less than a threshold, PNₐ is removed from the pilot activation set of the terminal, so that a handoff is finished,

Step 303: The terminal keeps the service status and continues moving from cell b to cell c to reach the area near the boundary of cells b and c.

Because the pilot signals of cells b and c are completely the same, when receiving the pilot signals of cells b and c simultaneously, the terminal only regards them as multiple paths of the pilot signal from a same “cell”, and can not detect different pilots, thus the handoff cannot be triggered.

Meanwhile, because the forwarding synchronous and paging channel signals of cells b and c are completely the same, the synchronous and paging messages of various kinds received in cell c by the terminal are completely the same as that received in cell b. Moreover, since the base station side uses the other cells with the same PN in the multiple cells with the same PN as sectors added by a softer handoff, the service channel has opened cell c as a sector of the softer handoff, and the call can be kept normal.

Step 304: In the procedure that the terminal keeps the service status and moves from cell c to cell g, same as step 303, the signals received by the terminal in the area c, d, e, f and g are completely the same, so that the terminal cannot find that it is moving in six cells, and can only obtain one PN₀ in cells c, d, e, f and g. When a mobile phone is calling or called in the area c, d, e, f and g, the terminal can call or be called indistinctively in any one of the cells b, c, d, e, f and g with the same PN.

When the terminal establishes a call successfully and is in the service status, because the base station side uses the adding flow of the softer handoff to all the adjacent cells with the same PN for processing, the terminal can perform the service flow indistinctively in any cell of the area b, c, d, e, f and g.

Step 305: In the procedure that the terminal keeps the service status and moves from cell g to cell h to reach point H, for the same reason of step 302, one handoff flow is performed.

It can be concluded from the above specific implementing steps that in the area with the same PN, the terminal can only search the pilot signal of the same PN, so it cannot trigger a handoff flow, and thus the handoff will not occur within the whole area with the same PN. As described in the implementing steps above, before the application of the technology of the present invention, when moving from A to H, the terminal needs to cross the boundaries of the cells for seven times, which theoretically means seven handoffs. After the application of the technology of the present invention, when the terminal moves from A to H, the handoff occurs only twice when the terminal crossing the boundaries of the dark and light areas. For the whole system using the technology of the present invention, the handoff frequency is obviously reduced.

According to one embodiment the present invention, a code division multiple access wireless cellular communication system is also provided.

FIG. 5 is a structural schematic diagram of a code division multiple access wireless cellular communication system according to an embodiment of the present invention. As shown in FIG. 5, the code division multiple access wireless cellular communication system according to the embodiment of the present invention includes: multiple cells 50 (i.e. n cells of cell 50-1 to cell 50-n in FIG. 5, where n is a natural number greater than or equal to 2) and a terminal 52. In the above, the multiple cells 50 are adjacent or close in physical location and transmit the same pilot channel signal by using the same forwarding pilot pseudorandom noise; and the terminal 52 is used for receiving the pilot channel signal sent by the multiple cells 50 and demodulating the pilot channel signal to obtain the forwarding pilot pseudorandom noise.

Because the multiple cells 50 transmit the same pilot channel signal by using the same forwarding pilot pseudorandom noise, the forwarding pilot pseudorandom noises demodulated by the terminal 52 from the received pilot signal of each cell are the same. Therefore, when the terminal is moving within the coverage of the cell, the handoff will not occur, so as to reduce the frequency of handoff and avoid the call drop caused by the frequent handoff.

As stated above, with the technical solutions provided by the embodiments of the present invention, several cells which are adjacent or close in physical and geographical location transmit the same pilot channel signal by using the same pilot PN, so that the pilot channel signals received by a terminal within the coverage of these cells are the same, which equivalents to increasing the radius of the cell, thereby obviously reducing the handoff frequency when the terminal is on standby or in a conversation, and further reducing the instability of the system cased by frequent handoff, and the call drop rate. Furthermore, because the handoff will consume the bandwidth resource, and the embodiments of the present invention avoid the handoff, the bandwidth resource is saved effectively too.

The above are only preferred embodiments of the present invention and not used for limiting the present invention. For those skilled in the art, the present invention may have various modifications and changes. Any modifications, equivalent substitutions, improvements and the like within the spirit and principle of the present invention shall fall within the scope of protection of the present invention.

1. A signal covering method, applied in a code division multiple access wireless cellular communication system, the method comprising:
multiple cells which are adjacent or close in physical location transmitting a same pilot channel signal by using a same forwarding pilot pseudorandom noise.

2. The method according to claim 1, wherein after the step of transmitting the pilot channel signal, the method further comprises:
a terminal receiving the pilot channel signal transmitted by the multiple cells, and demodulating the pilot channel signal to obtain the forwarding pilot pseudorandom noise.

3. The method according to claim 2, wherein after the step of demodulating the pilot channel signal to obtain the forwarding pilot pseudorandom noise, the method further comprises:
if the strength of the pilot channel signal is greater than a preset first threshold, the terminal adding the forwarding pilot pseudorandom noise into a pilot activation set of the terminal.

4. The method according to claim 2, wherein after the step of demodulating the pilot channel signal to obtain the forwarding pilot pseudorandom noise, the method further comprises:
if the strength of the pilot channel signal is smaller than a preset second threshold, the terminal removing the forwarding pilot pseudorandom noise from a pilot activation set of the terminal.

5. The method according to claim 1, wherein the method further comprises:
the multiple cells transmitting, under control of a base transceiver station, a same synchronous channel signal.

6. The method according to claim 1, wherein the method further comprises:
the multiple cells transmitting, under an individual control of a base transceiver station or a combined control of the base transceiver station and a base station controller, a same paging channel signal.

7. The method according to claim 1, wherein the method further comprises:
reverse access channels of the multiple cells using a same long code mask.

8. The method according to claim 7, wherein the method further comprises:
a base station side receiving a reverse message sent by a terminal which is in any one of the multiple cells; and
the base station side demodulating the received reverse message according to the long code mask.

9. The method according to claim 1, wherein the method further comprises:
when a terminal is calling or called in any one of the multiple cells, a base station side using the other cells in the multiple cells as sectors added by a softer handoff.

10. A code division multiple access wireless cellular communication system, comprising:
multiple cells, each of which transmits a same pilot channel signal by using a same forwarding pilot pseudorandom noise, wherein the multiple cells are adjacent or close in physical location; and
a terminal, configured to receive the pilot channel signal transmitted by the multiple cells, and demodulating the pilot channel signal to obtain the forwarding pilot pseudorandom noise.

11. The method according to claim 3, wherein after the step of demodulating the pilot channel signal to obtain the forwarding pilot pseudorandom noise, the method further comprises:
if the strength of the pilot channel signal is smaller than a preset second threshold, the terminal removing the forwarding pilot pseudorandom noise from a pilot activation set of the terminal.
